(19) United States
(12) Patent Application Publication
(10) Pub. No.: US 2018/0162772 A1
(43) Pub. Date: Jun. 14, 2018

(54) Method for Manufacturing a Design Article

(71) Applicant: ARCONS Limited, Hong Kong (CN)

(72) Inventor: Bongchull Shin, Munich (DE)

(21) Appl. No.: 15/894,120

(22) Filed: Feb. 12, 2018

Related U.S. Application Data
(63) Continuation-in-part of application No. PCT/EP2016/069182, filed on Aug. 11, 2016.

(30) Foreign Application Priority Data
Aug. 11, 2015 (DE) 10 2015 113 203.6

(51) Int. Cl. C03C 27/10; B32B 7/12; B32B 17/10

(52) U.S. Cl. CPC C03C 27/10; B32B 7/12; B32B 2451/00; B32B 17/10733; B32B 17/10651

(57) ABSTRACT

A method for manufacturing a design object from a plurality of glass sheets. The method comprises cleaning at least one surface of a glass sheet, mixing a dye in a solvent to form a coloured mixture, mixing a hardener into the coloured mixture and filtering the coloured mixture. The filtered coloured mixture is mixed with an epoxy resin to form a coloured resin and the coloured resin is applied in one direction to the cleaned at least one surface of the glass sheet and allowed to dry.

### CROSS-REFERENCE TO RELATED APPLICATIONS

This application is a continuation-in-part of international patent application No. PCT/EP2016/069182, filed on 11 Aug. 2016, and claims priority of and benefit to the Patent Application DE 10 2015 113 203, filed 11 Aug. 2015. The entire content of the German Patent Application DE 10 2015 113 203 and the international patent application PCT/EP2016/069182 are hereby incorporated by reference.

### BACKGROUND OF THE INVENTION

### Field of the Invention

The invention relates to a method of manufacture of a design object.

### Description of the Related Art

A decorative glass block bearing a design is known, for example, from US Patent Application Publication No US 2004/0163759, which teaches cutting a hollow glass block into two halves and then inserting a translucent sheet bearing a design between the cut edges of the two halves of the blocks.

A method for connecting a first glass-like plate to a second glass-like plate via an intermediate layer of adhesive material is known, for example, from Austrian Patent AT 385 949 B. The assembly of plates and adhesive is degassed in a vacuum chamber. The first glass-like plate is a thin plate, which is at most 3 mm, but preferably 1.5 mm, thick. The Austrian Patent AT 385 949 B further describes that the intermediate layer of adhesive material is applied on both bonding plates with a thickness of at most 250 μm and a viscosity in the range of 15 to 300 P. The intermediate layer of adhesive material is settable by evaporation of a solvent or by hot or age hardening.

A material having a decorative effect is known, for example, from the German Patent DE 3533463 C1, which consists of at least two layers of transparent material, which are each provided with a transparent colored layer having a decorative effect. Layers of glass with a thickness of about 0.2 mm or plastic coatings (e.g. acrylic glass) are preferred as the transparent layers. The material with the decorative effect consists of several layers made of transparent material, e.g. white glass, in which a color effect layer is either printed, deposited, or otherwise applied thereon. The layers of transparent material with the effect layer are connected by means of a transparent adhesive layer, e.g. made from UV or epoxy adhesive. On the top end of the effect material an arched portion is applied by means of the same transparent adhesive. This base support, which is also adhesively bonded, forms the end of the effect material. This arched portion constitutes a base support, which is either self-adhesive (black glass) or provided with a cover or reflective layer. The German Patent DE 3533463 C1 describes that good optical effects are achieved when several effect layers are used by separating each effect layer with the transparent material layer with different colors, as in each effect layer the color pigments are arranged differently resulting different color matches, i.e. a depth effect, as viewed from above.

A laminated glass is known, for example, from German Patent Application DE 198 36 694 A1, in which the laminated glass is obtained by insertion of an adhesive between at least two glass panels to form a sandwich assembly by pressing and hardening of the adhesive. The adhesive has a viscosity of 5-300 Pa·s and a yield point of 5-800 Fa in the liquid form on the inner side of the first horizontal glass panel. The adhesive is preferably based on silicone, epoxy resin, polyurethane, polyester or poly (meth) acrylate. The second glass panel is applied to this adhesive layer to form the sandwich assembly. After curing the adhesive layer, by thermal radiation or by means of radical or preferably by irradiation with UV light, the adhesive layer has a layer thickness of 0.2 to 5 mm, preferably 0.5 to 2 mm.

A method is known, for example, from EP 0 864 444 A1 that allows a production of decorative materials having different and individually pre-determinable color and texture effects as well as depth effect of a three-dimensional structure. At least one pigment and/or dye-containing curable resin layer is applied on a transparent substrate, and subsequently a fiber composite material is applied thereon, wherein in the at least one resin layer a platelet-shaped effect pigment is included. The proportion of the pigments and/or dyes in the resin layer depends essentially on the desired effect, but is usually in the range of about 1 wt.-% to 20 wt.-%. The individual ones of the resin layers normally have a thickness of about 0.5 mm to about 2 mm, in particular from about 0.5 to about 1.5 mm. If several layers are applied, a total thickness of about 2 mm to 3 mm is not exceeded.

It is known that it is possible to glue glass sheets together to form a glass block, which can be used as a design object. However, it is very difficult to ensure that there are no gas bubbles trapped between the glued glass sheets. The presence of the visible gas bubbles can detract from the aesthetic pleasure of the design object and there is therefore a need to develop a method to avoid the presence of gas bubbles.

It is an object of the present invention to provide a method for manufacturing of a design object from a plurality of glass sheets of any thickness having a coloured and transparent adhesive without any visible gas bubbles between the glass sheets.

### SUMMARY OF THE INVENTION

This document teaches a method for manufacturing a design object from a plurality of glass sheets without any visible gas bubbles between the glass sheets. The design object can be used as artwork itself or can be attached, for example, to a façade of a building.

The method of this document comprises cleaning at least one surface of a glass sheet and then mixing a colorant in a solvent to form a coloured mixture. A hardener is subsequently added into the coloured mixture and the mixture filtered. The filtered coloured mixture is mixed with an epoxy resin to form a coloured resin and this coloured resin is applied to the cleaned at least one surface of the glass sheet. Finally, the method comprises allowing the coloured resin to dry. The colorant is preferably a soluble dye.

In one further aspect of the method, the coloured resin is applied in a single direction on the cleaned surface of the glass sheet. This application in a single direction avoids the risk of trapping gas bubbles in pockets created by different brush strokes in different directions.

A further aspect of the method is to apply a transparent resin to surface of a further one of the glass sheets. This transparent resin enables different glass sheets of with alternating different coloured resins to be stuck together to form the design object.

The coloured resin is allowed to stand for around 30 minutes before applying the coloured resin to the at least one surface. After application, the coloured resin dries for at least three days.

Other object features aspects and advantages of the disclosed method for manufacturing a design object and a design object made using the method will become apparent to those skilled in the art from the following detailed description.

### BRIEF DESCRIPTION OF THE DRAWINGS

The invention will now be explained in more detail with reference to the following figures. It will be understood that the embodiments and aspects of the invention described in the figures are only examples and do not limit the protective scope of the claims in any way. The invention is defined by the claims and their equivalents. It will be understood that features of one aspect or embodiment of the invention can be combined with a feature of a different aspect or aspects of other embodiments of the invention. This invention becomes more obvious when reading the following detailed descriptions of some examples as part of the disclosure under consideration of the enclosed drawings. Referring now to the attached drawings which form a part of this disclosure.

FIG. 1 shows a design object comprising a plurality of glass sheets made using the method of this invention.

FIG. 2 shows an outline of the method of this invention.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

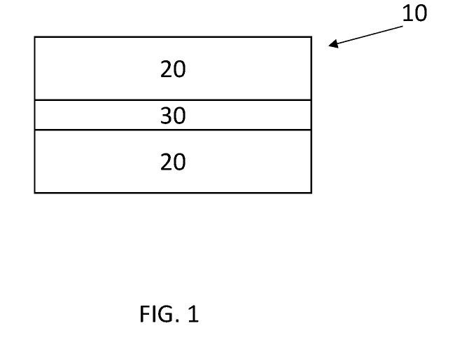

FIG. 1 shows a design object 10 with a plurality of glass sheets 20. The plurality of glass sheets 20 are glued together by an adhesive layer 30. The adhesive layer 30 is made using a coloured epoxy resin made using the method of the disclosure, or a transparent epoxy resin. Alternatively, the adhesive layer 30 can be made from an acrylate-based adhesive, which can be hardened with UV light. One non-limiting example of the acrylate-based is CONLIC UV 665.

The glass sheets 20 used in one aspect of the invention are made from a glass with low iron content supplied by Pilkington Glass and sold under the trade name Optiwhite®. It would be possible to use other glasses for the manufacture of the design object 10 and the invention is not limited to the use of the low iron content glass. The glass sheets 20 with low iron content are preferable because the glass sheets have no “greenish” tinge. Indeed, it would be possible also to use clear polymers, such as but not limited to polymethylmethacrylate, to create the design object 10.

The glass sheets 20 can be formed of any thickness, preferably from about 1.5 mm between 10 mm. It will be noted that the glass sheets 20 can also be formed of a thickness larger than 10 mm.

The example of FIG. 1 shows only two glass sheets and a single adhesive layer 30. A plurality of glass sheets 20 may be incorporated into the final design object 10 and the invention is not limited to the design object 10 made from two glass sheets 20.

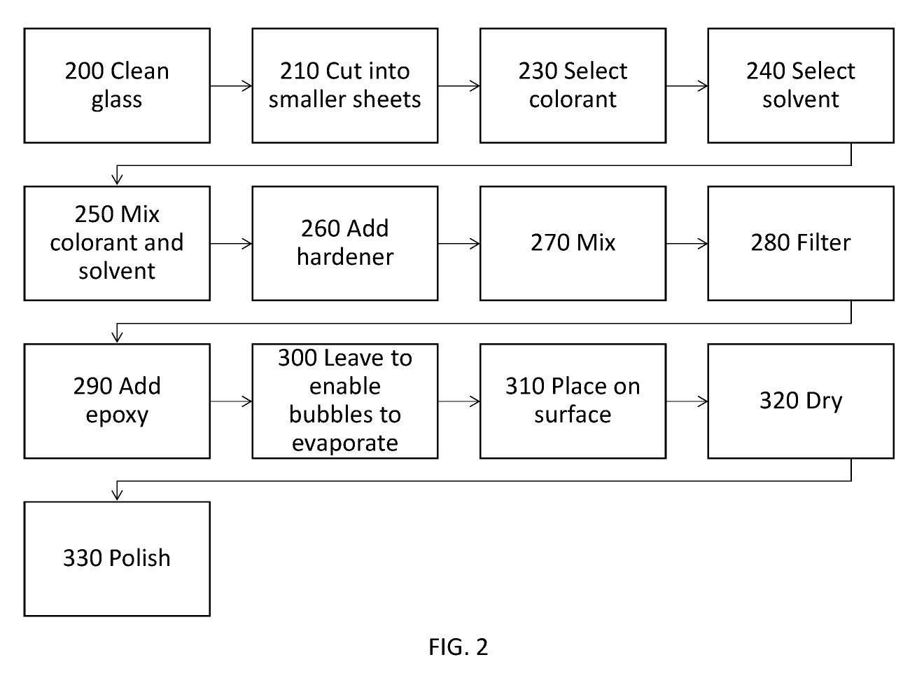

FIG. 2 shows a method for the manufacture of the design object. In a first step 200, a large piece of glass is cleaned and in step 210 cut into a number of smaller glass sheets 20. These smaller glass sheets 20 are then cleaned using, for example, a cleaning fluid, such as those supplied by Bohle or 3M, and cloth made from a combination of viscose and polyester, supplied by Bohle.

The glue colouring is prepared in step 230 by selecting a colorant, such as a soluble dye, and in step 240 by selecting a solvent. The soluble dye is, for example Orasol dye supplied by BASF. The solvent is, for example, an alcohol. In one non-limiting embodiment of the invention 0.1 g of orange G dye is used and a solvent of ethyl alcohol or butyl alcohol. The dye and the solvent are mixed for 3-4 minutes in step 250 until the soluble dye dissolves in the solvent to create a coloured mixture. The hardener is initially added to the coloured mixture in step 260 and mixed for 4-5 minutes in step 270 using a spatula.

In step 280, the coloured mixture with the hardener is filtered to remove any undissolved particles of the dye and any gas bubbles that may be present in the solution. An epoxy resin is mixed with the hardener/coloured mixture in step 290 for 4-5 minutes with a spatula to form a coloured epoxy with hardener. A ratio of three parts coloured hardener to ten parts of epoxy was used.

The coloured epoxy and hardener solution is left to stand for 30 minutes in step 300 to allow any gas bubbles within the coloured epoxy and hardener to disappear. The epoxy used is, for example, a transparent epoxy with article number SKresin72 made by S and K Hock GmbH, Regen, Germany, and available from www.harzspezialisten.de.

In step 310 the coloured epoxy and hardener solution is placed on a cleaned surface of one or more of the glass sheets 20 (which term also includes other forms of glass objects, such as blocks). This is done very slowly, preferably applying the solution in one direction, e.g. left to right, and care is taken that no bubbles form in the layer of the solution on the surface of the glass sheet 20. The surface of the glass sheet 20 is covered with the solution.

The coloured epoxy and hardener solution has a viscosity of about 0.5 Pa·s with a mixing ratio epoxy:hardener of 10:3, wherein the coloured epoxy has an amount of colour pigments of about 0.06 g to 0.10 g per 4.5 g of hardener, i.e. in the range of about 1.2 wt.-% to 2.2 wt.-%. The epoxy resin can, for example, be formed of the epoxy resin SKresin 72, which is a high quality resin and which is based on two components. Having a light stabilizing factor, i.e. stable to ultra-violet light, a yellowing of the cured epoxy resin is prevented. The curing of the epoxy resin is accomplished by adding the hardener Epohard-hardener 5072 to the epoxy resin in step 290. Therefore, on large surfaces or complex 3D impressions, crystal clear, transparent and bubble-free casting results can be accomplished. The hardener is solvent-free, long-term UV-stable, dries tack-free and has a high water resistance. The epoxy resin SKresin 72 and the Epohard-hardener 5072 have the following technical data as set out in the following table:

| | | Epohard-hardener | |
|---|---|---|---|
| Technical Data | epoxy SKresin 72 | 5072 | mixture |
| Viscosity | 1500 mPa · s | 100 mPa · s 2/6r | 500 mPa · s 2/6r |
| | 2/6r Brookfield | Brookfield | Brookfield |
| Density | 1.1 g/cm³ | / | / |
| Mixing ratio | 1.00 wt.-% | 0.30 wt.-% | 1.30 wt.-% |

| | |
|---|---|
| Processing | 18°-25° C. |
| temperature | |
| Processing time | 120-240 minutes |
| Curing time | Tack-free after 72 hrs. at 20° C. |
| | Final strength after 7 days at 20° C. |

A cleaned surface of another one of the glass sheets 20 is then placed on the solution very carefully in one direction e.g. from left to right or one end of the another one of the glass sheets 20 to the other end of the glass sheet 20, during which time there is a constant checking for bubbles. This cleaned surface has no coloured layer or transparent resin layer. If there are any bubbles formed and visible after close inspection the placed glass sheets needs to be slightly lifted and placed back again until all bubbles are gone. The glass sheets 20 are left to dry for around three days in step 320. This forms a pair of the glass sheets. It would be possible to place the glued glass sheets in an oven at around 45°-50° to speed up this process.

The thickness of the epoxy resin layer after drying is substantially uniform with a dimension of less than a millimetre, preferably to a substantially uniform thickness of about 0.02 mm (+/−0.01 mm), but this is not limiting of the invention. This very thin epoxy resin layer is substantially invisible to the naked eye, when viewed inline from the side. As the pair of glass sheets is rotated, the coloured epoxy resin becomes more noticeable and the intensity of the colour will appear to increase.

In a further embodiment of the method one or more of the pairs of glass sheets or the glass blocks formed from the plurality of glass sheets are glued together using a further resin layer, made for example from a transparent epoxy resin, another coloured epoxy resin or indeed the same coloured epoxy resin. The transparent epoxy resin is made in the same way as indicated above, except that no colorant is added to the epoxy resin. The further resin layer is added to the cleaned surface of a further pair of the glass sheets and then the cleaned surface from another pair of the glass sheets is placed in contact to stick the two pairs of the glass sheets together. The glass blocks can have different coloured resins so that the final design object created from the glass blocks has a multiple coloured design.

It is also possible to use pairs of glass sheets 20 which have already been stuck together with a transparent adhesive layer and then to clean their outside surfaces before the coloured epoxy is coated on one or both of the outside surfaces and another glass sheet 20 or pair of glass sheets 20 are carefully placed on the coloured epoxy layer, in a manner similar to that discussed above.

This method of sticking pairs of glass sheets 20 together can be continued to form the design object. In practice the design objects have one or more pairs of individual glass sheets 20 with the corresponding number of epoxy layers (both transparent epoxy layers and coloured epoxy layer) between the pairs of glass sheets 20. A viewer of the design object 10 will see, as the design object 10 is rotated, that the effect of the plurality of coloured epoxy layers is to change the intensity of the coloration of the design object 10. This is because after a certain angle, the viewer will effectively see two or more overlapping coloured epoxy layers.

In step 330, a polishing process is carried out on the design object 10 made from the one or more pairs of individual glass sheets 20 using a rotary sander or, preferably, a ProVetro profi disc grinder such as supplied by TKG GmbH. This polishing process is carried out when the pairs of glass sheets 20 are stuck together and the design object 10 is completed.

The design objects of the current description can be used to form decorative art pieces and applied to facades of buildings and can be used in different combinations. The design objects can also be used in jewelry.

From the above description of the present invention, those skilled in the art will perceive improvements, changes, and modifications on the present invention. Such improvements, changes, and modifications within the skill in the art are intended to be covered by the appended claims.

What is claimed is:

1. A method for manufacturing a design object from a plurality of glass sheets comprising:
cleaning at least one surface of a first glass sheet and at least one surface of a second glass sheet;
mixing a dye in a solvent to form a coloured mixture;
mixing a hardener into the coloured mixture;
filtering the coloured mixture;
mixing the filtered coloured mixture with an epoxy resin to form a coloured resin;
applying the coloured resin to the cleaned at least one surface of the first glass sheet; and
applying in a sideways fashion a second glass sheet such that the cleaned at least one surface of the second glass sheet is in contact with the coloured resin to form the design object.

2. The method according to claim 1, wherein the coloured resin is applied in one direction.

3. The method according to claim 1, further comprising applying a transparent resin to a first cleaned surface of a further first glass sheet, and applying a second cleaned surface of a further second glass sheet to the transparent resin.

4. The method according to claim 1, further comprising allowing at least one of the coloured resin or the transparent resin to stand for around 30 minutes before applying the coloured resin to the cleaned at least one surface.

5. The method according to claim 1, further comprising allowing the at least one of the coloured resin or the transparent resin to dry for at least three days.

6. The method according to claim 1, wherein the first glass sheet and the second glass sheet form a first pair of glass sheets and the further first glass sheet and the further second glass sheet form a second pair of glass sheets, the method further comprising
cleaning a first surface of the first pair of glass sheets and a second surface of the second pair of glass sheets
applying at least one of the coloured resin or the transparent resin to the cleaned at least one surface of the first pair of glass sheets; and
applying in a sideways fashion the second of glass sheets such that the cleaned at least one surface of the second pair of glass sheets comes in contact with the coloured resin or the transparent resin to form the design object.

7. The method according to claim 1, further comprising polishing the design object.
